(19) United States
(12) Patent Application Publication
(10) Pub. No.: US 2004/0109593 A1
(43) Pub. Date: Jun. 10, 2004

(54) Process for controlling an image recording and control apparatus therefor

(75) Inventor: Reiner Jung, Langgoens (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Wetzlar GmbH, Wetzlar (DE)

(21) Appl. No.: 10/726,925

(22) Filed: Dec. 3, 2003

(30) Foreign Application Priority Data
Dec. 4, 2002 (DE) DE 102 56 706.9

(51) Int. Cl. G06K 9/00

(52) U.S. Cl. 382/128

(57) ABSTRACT

A method for controlling image recording includes actuating, using a control unit, equipment for the image recording. Image data of the recorded images is processed using a computer unit. Control commands for the image recording are combined to form a script. The script is transmitted from the computer unit to the control unit.

This invention relates to automated image acquisition and image analysis systems. In particular it relates to apparatus and methods for the high-throughput acquisition and analysis of images of fluorescent or chemically stained biological materials.

### BACKGROUND OF THE INVENTION

Many procedures require the analysis of signals derived from biochemical reactions.

For example, cell-based assays have been developed or adapted to generate chromogenic or fluorogenic signals which can be detected by hotomultipliers or imaging devices. Also, fluoroimmunoassay techniques employ fluorochromes attached to antibodies to detect the presence of specific biological moieties. Analyzing the resulting signals derived from these moieties completes the assay. Another example is the use of Green Fluorescent Protein (GFP) to determine tranansfection or transformation efficiency in genetic engineering without harming the living cell. Also, cellular assays are done to determine the efficacy of antibiotic developments, or in the use of molecular probes to investigate biological processes. Thus, signals from fluorescently stained samples are generated in connection with biological, biomedical, and immunoserological applications. There are several current methods for analyzing such signals.

For example, fluorescent plate readers detect light transmitted from wells in a microtiter plate. According to this technique, light is collected serially or simultaneously from each well in the microtiter plate and directed via a fiber optic cable or lenses to a photomultiplier. A background level of fluorescence is determined by averaging light from the ensemble of unlabeled wells. Wells that exceed the background level of light give positive results. Because plate readers integrate over a large number of individual wells or across the entire microtiter plate, they cannot detect single cells. Instead, fluorescent plate readers usually require a minimum level of approximately 200 stained cells for successful signal detection within any particular well in the microtiter plate. Although plate readers do not provide microscopic resolution of individual cells, linearity over a limited dynamic range may be observed.

Fluoroimagers operate similarly, but instead of passively collecting the light they scan and image the microtiter plate with an array of CCD sensors. Because of the typically low spatial resolution of these fluoroimagers, a number of cells may occupy a given pixel and cannot be separately imaged. Thus, like fluorescent plate readers, fluoroimagers usually cannot detect single cells within a sample. In particular, quantitation of GFP expression levels poses some difficulties because the heterogenous expression levels and the low quantum yield of the protein produces relatively small amounts of fluorescence per active cell. The utility of fluoroimagers or fluorescent plate readers for quantitation of transfection efficiency or expression is therefore rather limited, requiring the use of fluorescence-activated cell sorters.

A type of flow cytometer commonly referred to as a fluorescence-activated cell sorter (FACS), can detect single transgenic GFP cells. However, FACS machines require trypsinization to disassociate adherent cells because the sorter processes cell suspensions. Trypsinization may damage the cells and affect the cellular assay accuracy. FACS machines, while having greater sensitivity than fluorescent plate readers or fluoroimagers, do not possess the high throughput of these analyzers because they analyze only a single cell at a time and require the time consuming trypsinization procedure.

Automated analysis of images from a camera-mounted fluorescent microscope provides the single cell sensitivity of a FACS device without the need for trypsinization and with much greater throughput. Price et al. (U.S. Pat. No. 5,548,661) describe one such system analyzing specimens on microscope slides. However, it is difficult to culture cells on glass slides as compared to microtiter plates, and numerous glass slides are necessary to duplicate experiments performed on a single microtiter plate. Thus, there is a need for an automated image acquisition and image analysis system which combines the sensitivity of FACS machines with the high throughput of fluorescent plate readers and fluoroimagers without the need for trypsinization.

### SUMMARY OF THE INVENTION

It is an object of the invention to perform quantitative cell assays, such as proliferation assays, toxicity assays, ELISAs, and quantitation of transfection experiments and reporter gene expression. For example, reporter gene expression is used to screen delivery vehicles or to test the effects of drugs on transcription and translation. Non-radioactive reporter genes, such as Green Florescent Protein (GFP) and luciferase have been developed for this purpose.

It is a further object of the invention to classify samples into “positive” or “negative” classes. For example, the invention will detect the number of cells going through S-phase as compared to the total number of cells in the sample. The number of living cells may be determined by the number of Syto 13 stained cells, the number of total cells may be determined by ethidium homodimer staining.

In one embodiment of the invention, images of samples contained in a plurality of wells may be obtained from a camera mounted to a microscope by scanning the plurality of wells with a stage controller. Preferably, the plurality of wells comprises 10 or more wells, particularly preferred are 96 wells. The images are digitized and analyzed according to their features such as absorbance, fluorescence intensity, or morphology in order to image and count individual cells.

The advantage of the current invention in one embodiment lies in the fact that the final signal output is binary. In non-imaging devices signals are integrated. A composite signal is derived from specific staining unspecific staining and the background. Furthermore, differential staining results in differential output. For counting purposes, this may not be ideal. In one embodiment, the instrument described below does not differentiate between cells stained to different degrees because of its binary output. In another embodiment, it is not necessary to resolve individual cells but instead quantify cells by merely digitizing the obtained image pixels and establishing a threshold value based upon pixel intensity.

Other objects and features of the invention are illustrated by the following description and claims.

### BRIEF DESCRIPTION OF THE DRAWINGS

FIG. 1 is a diagrammatic representation of one embodiment of the invention.

FIG. 2 is a block diagram of software components in the invention according to one embodiment of the invention.

FIG. 3 is a flow chart representation of the image acquisition process according to one embodiment of the invention.

FIG. 4 is a flow chart representation of the image analysis process according to one embodiment of the invention.

FIG. 5A illustrates an image collected by the invention prior to image analysis.

FIG. 5B illustrates an image collected by the invention after image analysis.

FIG. 6 is a chart illustrating growth analysis by counting at various magnifications according to one embodiment of the invention.

FIG. 7 is a chart illustrating growth analysis by area at various magnifications according to one embodiment of the invention.

### DETAILED DESCRIPTION OF THE EMBODIMENTS OF THE INVENTION

The present invention relates to U.S. Provisional Application No. 60/073,023, filed on Jan. 29, 1998, which is hereby incorporated by reference in its entirety. The present invention further relates to a system that provides automated image acquisition and image analysis of biological material contained in a plurality of wells such as those of a microtiter plate. Images of samples contained in the wells are magnified and captured. The captured images are then analyzed. More specifically, in one embodiment, the images of samples in a microtiter plate can be obtained from a camera mounted to a microscope such as an inverted epifluorescence microscope. Images can be obtained from any or all of the plurality of wells by scanning the microtiter plate with a mechanism such as, for example, a stage controller. To facilitate analysis, the images can be digitized. The final images can be analyzed according to their features such as, for example, absorbance, fluorescence intensity, or morphology.

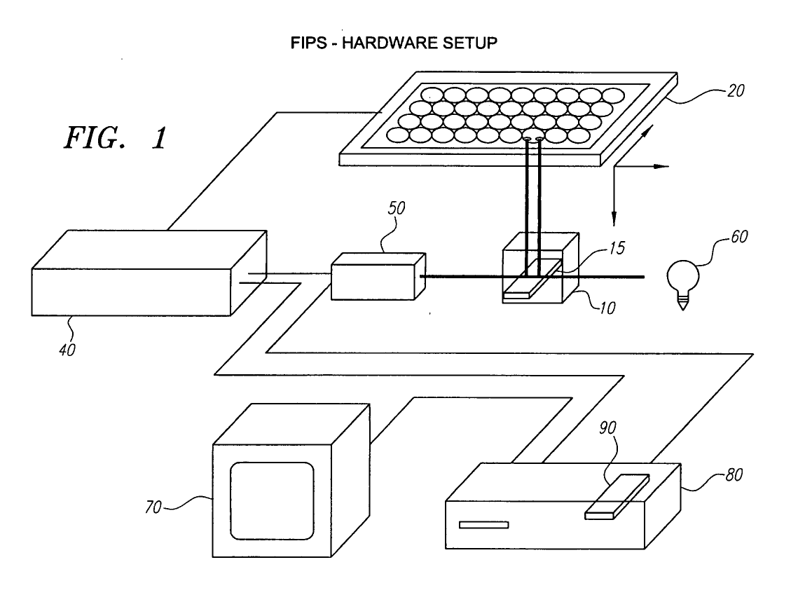

An illustration of a preferred embodiment of the invention is shown in FIG. 1. As discussed above, the samples are preferably provided in a plurality of wells, such that images from a plurality of samples can be acquired and analyzed. In a preferred embodiment, the plurality of wells is implemented utilizing a microtiter plate 20. According to the illustrated embodiment, an inverted epifluorescence microscope 10 provides magnification of samples contained in microtiter plate 20.

An illumination source 60 illuminates the samples. In one embodiment, illumination source is a high-pressure mercury lamp 60.

Filtering techniques can also be utilized to accommodate multiple chromophores or fluorophores. For example, as illustrated in FIG. 1, appropriate filter cubes 15 with interference filters and dichroic mirrors are used in conjunction with the microscope 10 to accommodate multiple chromophores or fluorophores.

To obtain images from the plurality of wells, microtiter plate 20 is moved relative to the imaging device. In one embodiment, microtiter plate 20 is mounted on a motorized stage 30, and the motorized stage is moved in the x, y and z directions. As illustrated in FIG. 1, in this embodiment, stage 30 is operated by an XYZ stage controller 40. Preferably, software in a computer 80 directs movement of the stage 30 by stage controller 40 in order to scan the wells in microtiter plate 20. A raster-type scan pattern is ordinarily suitable to provide coverage of each well, although alternative scan patterns can be implemented as well.

In one embodiment, commercially available software such as, for example, Stage Pro by Mediatech can be used to direct stage controller 40 to generate the scan pattern and then position the microtiter plate 20 to sequentially bring each desired well within the objective field of microscope 10.

As would be apparent to one of ordinary skill in the art after reading this description, alternative techniques can be utilized to control the position of microtiter plate 20 relative to microscope 10, including techniques which position microscope 10 while maintaining the position of microtiter plate 20 fixed.

A camera 50 connected with microscope 10 records the images. Suitable cameras can include, for example, the Hitachi HVC20 CCD camera. As would be apparent to one of ordinary skill in the art after reading this description, other types of cameras may be used without departing from the general principles of the invention.

As described above, digitization of the captured image facilitates analysis in one embodiment. In the embodiment illustrated in FIG. 1, a frame grabber 90 is used to digitize the captured analog image. Frame grabber 90 can be implemented using, for example, the commercially available Imagraph Imascan which provides a resolution of 640 by 480 pixels per frame.

The RBG image can be converted to a monochrome image without loss of relevant information (fluorescence intensity) and compressed to conserve storage space. In one embodiment, the digitized images are stored as a monochrome JPEG file with 25% compression. As would be apparent to one of ordinary skill in the art after reading this description, compression formats other than JPEG can be utilized. Experimentation with the JPEG compression format indicates that beyond 25% compression the image degradation affects the assay accuracy.

A monitor 70 is provided in the illustrated embodiment to allow an operator to supervise image quality, although in one embodiment, the invention can run without human intervention. Filenames can be given to each successive image to identify the date, time, and position of the analyzed well in microtiter plate 20.

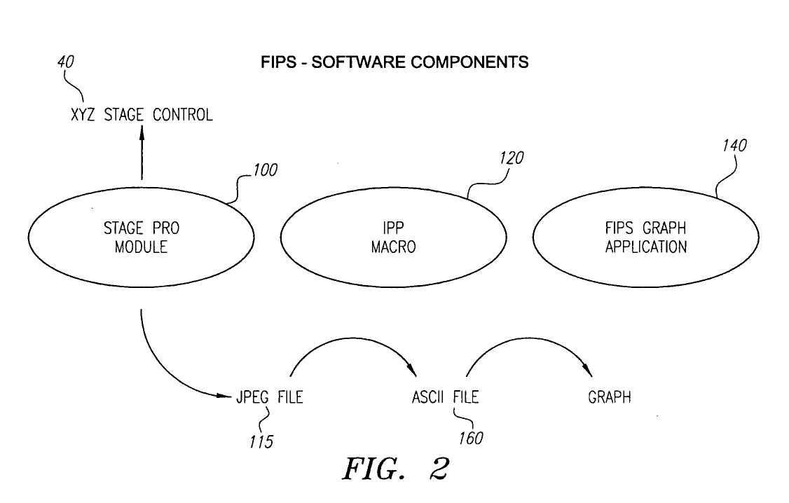

FIG. 2 illustrates is a diagram illustrating functionality utilized to implement the invention according to an example embodiment; in one embodiment, this functionality is implemented using software components. Stage module 100 provides the functionality to operate stage controller 40 so as to initially position a well of microtiter plate 20 within the objective field of microscope 20, autofocus the image, and complete the scan pattern of the well. This functionality can be implemented using commercially available software such as, for example, Stage Pro by Mediatech. Because microtiter plates 20 are typically manufactured with precise tolerances with the cells adhering to the well surface, autofocus can normally be implemented with a high level of accuracy and accomplished fairly rapidly. However, in alternative embodiments, manual focusing can be implemented if necessary or otherwise desired. As discussed above, in a preferred embodiment the captured images are digitized and compressed. Accordingly, a compressed digital file, such as, for example, a JPEG file 115 is produced.

Image processing module 120 performs the image analysis on the captured images in file 115. Specifically, in one embodiment, image processing module 120 analyzes spectral features contained in the JPEG files 115 representing the digitized images. In one embodiment, image processing module 120 identifies and counts cells or organelles that satisfy predefined requirements. The total number of such identified objects is calculated and saved in a data file 160 together with a positional number corresponding to the location of the well. In one embodiment, data file 160 is an ASCII file.

Although this processing can be implemented using a specialized digital image processor, satisfactory results can be obtained from commercially available image processing software such as, for example, Image Pro software running on a general purpose computer. As would be apparent to one of ordinary skill in the art after reading this description, other image processing software modules can be implemented to process the digitized images.

A graphics module 140 processes the information contained in the data files 160 to provide the results of the analysis. Preferably, graphics module produces a numerical and graphical representation of the number of identified cells per well. Averages and standard deviations of replicate determinations can be automatically calculated and displayed.

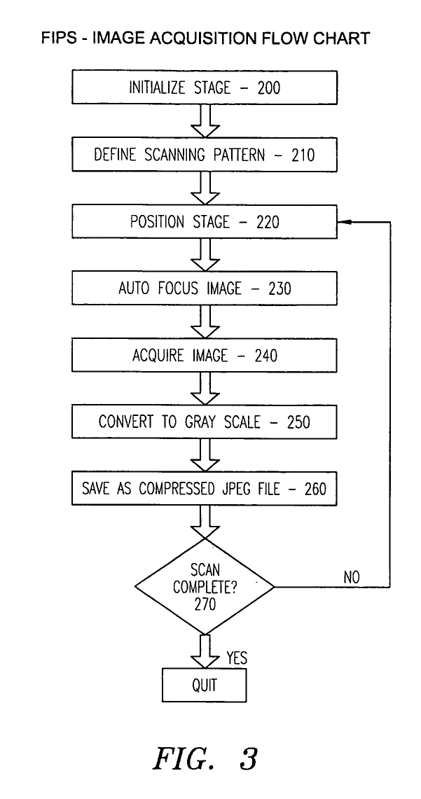

FIG. 3 illustrates an example process by which image acquisition can be performed by stage module software 100 according to one embodiment of the invention. At step 200, the stage is initialized to a starting position.

The scanning pattern is defined at step 210. Although a raster-type scan pattern provides satisfactory results, it would be apparent to one of ordinary skill in the art after reading this description that other scanning patterns may be appropriate for a particular sample and plurality of wells. The stage is then positioned according to the defined scanning pattern at step 220.

After positioning the stage, autofocusing step 230 occurs. Because microtiter plates are manufactured to close tolerances with cells typically adhering to the surface of the wells, autofocusing at step 230 normally requires little change in the Z position of the stage.

The image is then captured and digitized by a frame grabber in step 240. The pixel levels of the digitized image are converted to a grey scale in step 250 and stored in compressed JPEG file 115 in step 260.

Decision diamond 270 determines whether the scan is complete. Preferably, this step determines whether there are any wells remaining to be scanned. If the scan is not complete, steps 210 through 270 are repeated to capture the image from the next well, otherwise the module exits at step 280.

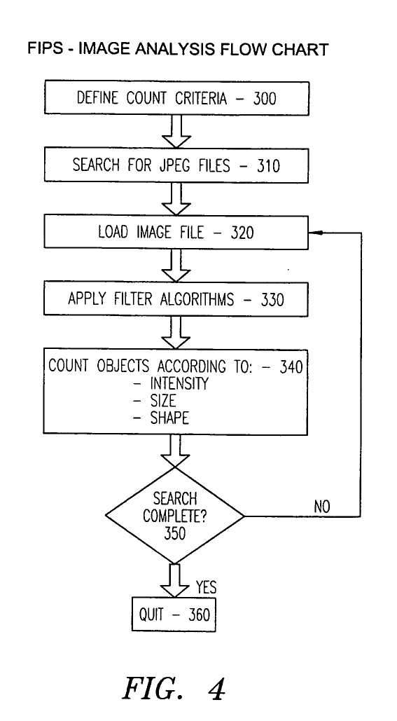

FIG. 4 illustrates an example process for image analysis performed by the image processing software module 120. The analysis begins with a definition of count criteria at step 300. In step 310, a search for JPEG files 310 is conducted. The appropriate image file 310 is loaded at step 320.

In the illustrated embodiment, the image is digitally filtered at step 330. Digital filtering enhances the image by, for example, image segmentation using watershed techniques. Image segmentation allows the analysis of clustered nuclei by determining the edges between adjacent nuclei. Although satisfactory results are obtained from the watershed technique, other filtering or image segmentation techniques can be used.

After enhancement of the image, the definition of the count criteria determines the counting of the desired objects at step 340. Criteria which can be utilized to determine whether an object exists and should therefore be counted can include, for example, object intensity, object size and the shape of the object.

For example, in assaying live rat smooth cells stained with Syto 13, a test to determine the presence of the cell nucleus is normally effective. Because the nucleus is typically brighter than the background, a test for intensity identifies likely cell nuclei. In addition, since the cell nucleus typically occupy a given number of pixels at a known magnification, a test for bright objects occupying an appropriate number of pixels can be used to help eliminate false identifications. Finally, a cell nucleus is commonly of a rounded shape, and thus a test that the X and Y dimensions are within a given tolerance of one another also helps to eliminate false positives. Although the combination of these three criteria can be used to accurately identify cell nuclei, it would be apparent to one of ordinary skill in the art after reading this description that alternative testing criteria can be utilized.

In step 350 it is determined whether there are additional files remaining to be analyzed. If there are remaining files, steps 320 through 350 are repeated, otherwise the module exits at step 360.

### EXAMPLE

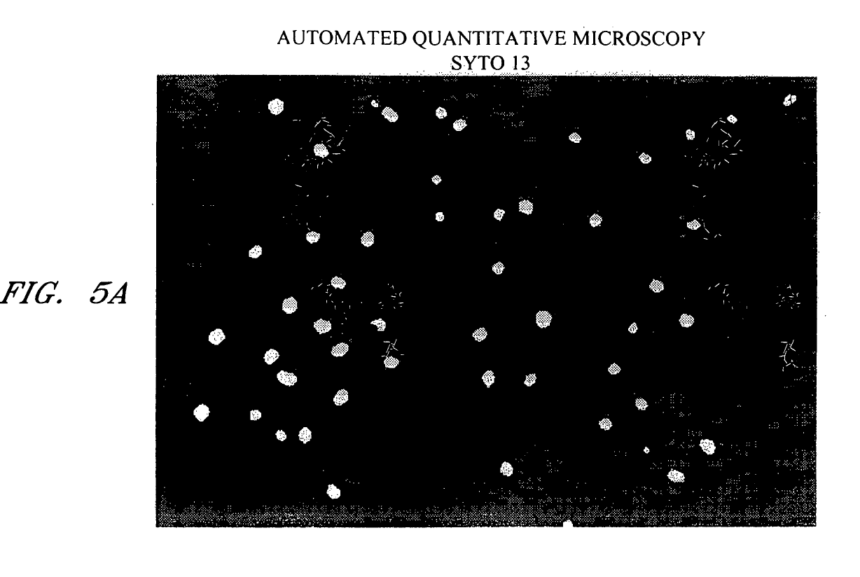

The above-described techniques are now further illustrated by way of a brief example. Using an embodiment of the invention as illustrated in FIG. 1, live rat smooth cells were disposed in a microtiter plate 20 and stained with Syto 13. In filter cube 15, the appropriate fluorescein filters were installed. FIG. 5A is a representation of an image obtained before digitization and analysis by the invention. As discussed earlier, the cell nuclei are brighter than the background, are of similar size, and are rounded. Thus, the count criteria shown in FIG. 4 can be used to identify the cells accurately.

FIG. 5B illustrates the image after analysis. The cells are counted and indicated by their individual number.

Although this example illustrated a single fluorochrome analysis, it would be apparent to one of ordinary skill in the art after reading this description, alternative embodiments of the invention can be implemented to analyze multi-label systems. For example, live rat smooth cells stained with Syto 13 and ethidium homodirner presents such a system. First, an analysis with the invention illustrated in FIG. 1 adapted with a fluorescein filter set 15 is conducted. Then an analysis with the invention illustrated in FIG. 1 adapted with a rhodamine filter set 15 is performed. For illustration purposes, the resulting images can be overlayed using standard image management software such as, for example, Photoshop. Intact, live cells are detected in the initial run with the fluorescein filter set, whereas dead or dying cells are detected with the rhodamine filter set.

In another example, the above-described techniques were employed to perform a sensitive, ratiometric proliferation assay. This assay is based on the observation that mitotic cells are noticeably more spherical than non-mitotic adherent cells. In order to visualize the more-spherical mitotic cells, calcein-AM (Molecular Probes, OR) is employed. Calcein-AM is a membrane-permeable, non-fluorescent compound which is converted by cytoplasmic esterases into a highly fluorescent, membrane-impermeable dye. Mitotic cells not only have a distinct shape, they exhibit significantly more fluorescence than their non-mitotic counterparts because the height of non-mitotic cells is significantly smaller than in mitotic cells. Therefore, the non-mitotic cells will have less calcein molecules in any given area segment. Because of the shape and fluorescent differences, the above-described invention may use shape and fluorescence intensity to distinguish cell populations.

The proliferation assay sensitivity is greatly enhanced by the addition of nocodazole which depolymerizes microtubules. In the presence of nocodazole, cells entering mitosis will undergo the usual morphological change (become more spherical), but they will not be able to complete cell division. Thus, all cells entering mitosis will get trapped as mitotic cells, exhibiting round cell bodies with bright calcein fluorescence.

Experiments have shown proliferation assays performed by the present invention have single cell sensitivity. These proliferation assays are as least as sensitive as 3H-thymidine incorporation techniques with the advantage of being non-radioactive. It is ratiometric because both mitotic and non-mitotic cells are quantified. This is advantageous should the initial cell number vary due to treatment or experimental error. Counting cells by conventional methods (such as a Coulter counter or MTT-assay) would have only produced a two-fold increase in signal strength over a 24 hour period. A much larger signal increase is observed with the calcein-AM proliferation assay. Non-imaging devices, such as plate readers, are not suitable to perform this assay. Nocodazole-arrested cells may also be detected after fixation and staining of cells with DNA-binding dyes such as CyQuant GR (Molecular Probes, OR).

As discussed earlier, fluorescent plate readers cannot resolve individual cells.

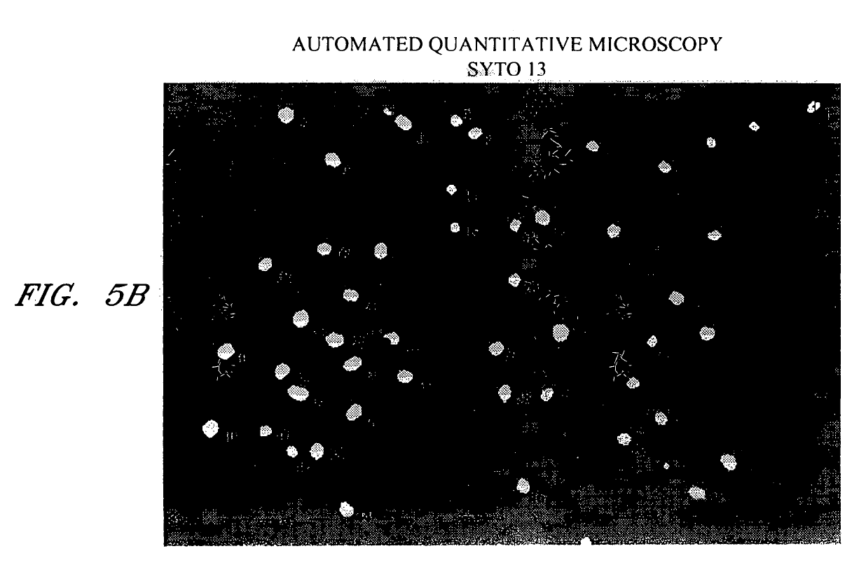

Nevertheless, despite their limited resolution, such plate readers exhibit linearity over a limited dynamic range. This suggests that it may not be necessary to resolve individual cells using the above-described invention. To investigate this hypothesis, MRC-5 cells were grown for 1-5 days and subsequently stained with CyQuant GR (Molecular Probes, OR). Plates were scanned using 10×, 4×, and 2×lenses. The resulting images were analyzed using the above-described cell imaging techniques in order to count individual cell nuclei. As expected, FIG. 6 illustrates that with decreasing magnification, the observed number of individual cell nuclei decreases. A seventeen-fold increase in cell numbers over a four day period is measured using a 10× magnification. Instead, if only a 4× magnification is used, the same cell culture appears to produce approximately a fourteen-fold increase. Moreover, if only a 2× magnification is used, the same cell culture appears to produce approximately a ten-fold increase in population. Notice that the smallest increase is observed with the Ascent fluorescence plate reader which observes only an approximate seven-fold increase in cell population.

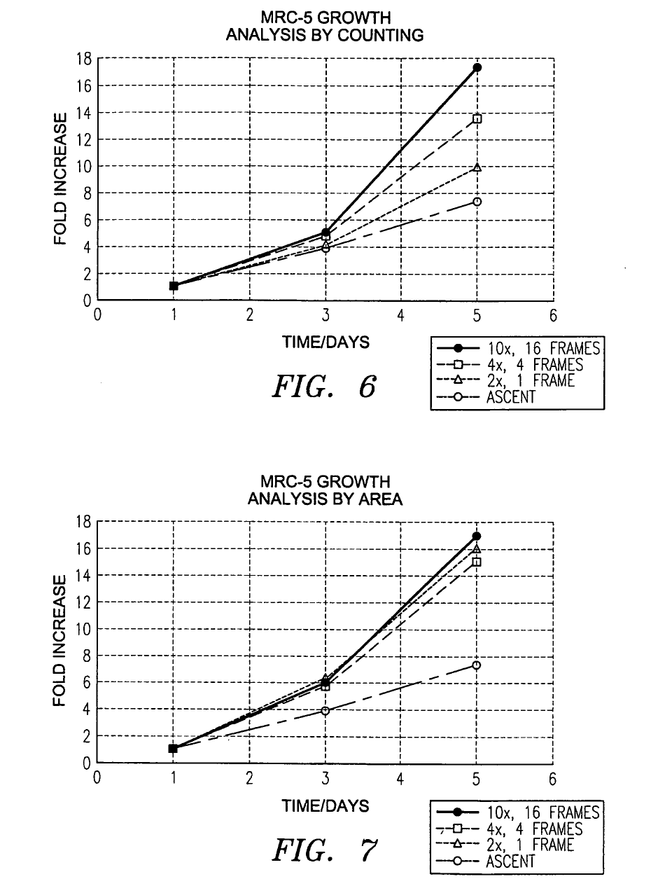

Turning now to FIG. 7, results from using the above-described invention when only pixels with an intensity greater than an automatically determined threshold are quantified. In this embodiment, the threshold was determined using conventional ImagePro software. Pixels are assumed to be normally distributed about a mean “bright” and a mean “dark” value. The threshold is set at the minimum value between the two gaussian distributions. Although at the lower magnifications, individual cell nuclei are not resolved, nevertheless; this embodiment of the invention illustrates remarkable similarity between the low and high resolution images.

At a 10×power magnification, an approximate seventeen-fold increase in cell population was observed. The 4× and 2×power measurements detected an approximate 16-fold and 15-fold increase. In contrast, an Ascent plate reader measuring the same cell culture detected only an approximate seven-fold increase in cell population. Using this embodiment of the invention greatly increases processing speed. For example, scanning a microtiter plate acquiring one image per well at a 2× magnification takes less than four minutes as compared with more than sixty minutes at a 10× magnification because significantly fewer frames of data are required.

While this invention has been particularly shown and described with reference to preferred embodiments thereof, it will be understood by those skilled in the art that various changes in form and details may be made therein without departing from the spirit and scope of the invention defined by the appended claims.

1. An apparatus for analyzing images of samples contained in a plurality of wells comprising:
a microscope for viewing the samples;
a camera for obtaining images from the microscope;
a stage controller for moving the plurality of wells in order to scan samples contained therein; and
an image processor for classifing samples according to a specific criteria based upon spectral features.

2. The apparatus of claim 1 wherein the image processor is a general purpose computer.

3. The apparatus of claim 1 wherein the image processor classifies samples according to their image intensity.

4. The apparatus of claim 3 wherein the image processor further classifies samples according to their size.

5. The apparatus of claim 4 wherein the image processor further classifies samples according to their roundness.

6. The apparatus of claim 5 wherein the camera is a CCD camera.

7. The apparatus of claim 1 wherein the plurality of wells comprises at least 10 wells.

8. The apparatus of claim 1 wherein the plurality of wells comprises at least 96 wells.

9. A method of analyzing images of samples contained in a plurality of wells, comprising:
scanning the samples by moving the plurality of wells relative to a camera;
acquiring images of the samples with the camera; and
classifying the acquired images of the samples according to a specific counting criteria based upon spectral features using an image processor.

10. The method of claim 9 wherein the acquired images of the samples are magnified.

11. The method of claim 9 wherein the classifying step classifies samples according to their image intensity.

12. The method of claim 11 wherein the classifying step further classifies samples according to their size.

13. The method of claim 12 wherein the classifying step further classifies samples according to their roundness.

14. The method of claim 10 wherein the camera is a CCD camera.

15. The method of claim 11 wherein the image processor is a general purpose computer.

16. The method of claim 12 wherein the samples in the microtiter plate are living cells.

17. A method of analyzing images of samples contained in a plurality of wells, comprising:
scanning the samples by moving the plurality of wells relative to a camera;
acquiring images of the samples with the camera; and
classifying the acquired images of the samples according to a specific counting criteria produced by a first fluorochrome using an image processor;
classifying the acquired images of the samples according to a specific counting criteria based upon spectral features produced by a second fluorochrome using an image processor; and
combining the classifications in order to perform an image analysis based upon the first and second fluorochromes.

18. A method for analyzing images of samples contained in a plurality of wells, comprising:
acquiring an image of two or more samples contained in the plurality of wells; and
classifying the samples according to a specific counting criteria based upon spectral features using an image processor.

19. A method of analyzing images of samples contained in a plurality of wells, comprising:
acquiring an image of samples contained in two or more of said plurality of wells; and
classifying the samples according to specific features of said captured images.
